(19) United States
(12) Patent Application Publication
(10) Pub. No.: US 2004/0242418 A1
(43) Pub. Date: Dec. 2, 2004

(54) Flood protection for banana and plantain plants

(76) Inventor: A. Harry J. Rajamannan, Minneapolis, MN (US)

Correspondence Address: Herman H. Bains, 6101 Tracy Avenue, Minneapolis, MN, 55436, US

(21) Appl. No.: 10/448,829

(22) Filed: May 30, 2003

(51) Int. Cl. A01N 63/00; A01N 63/02

(52) U.S. Cl. 504/118; 424/780

(57) ABSTRACT

A preventive method and composition for protecting roots of plants from root rot and to prevent the “corm” or the true stem of the banana and plantains from rotting when inundated by floods. The composition includes a nutrient which may be an acid, acid salt or salt derived from certain elements including calcium, phosphorous, potassium, magnesium, manganese, sodium, zinc, copper, iron cobalt, sulfur and chlorine. The composition also includes an organismic substance such as bacteria, fungi and viruses. The composition may be injected into banana or plantain plants or may be applied as a foliar spray.

### FIELD OF INVENTION

This invention relates to a method and composition for preventing plants, especially banana plants and plantain plants, from dying when the plants are inundated by floods and the plants and roots remain under water for more than 24 hours in the field.

### BACKGROUND OF THE INVENTION

All banana and plantains are grown in the tropics where rainfall is high. Often times the rivers adjoining the banana plantation farms flood and these flood waters inundate the fields. If these plants stand in the flood waters for more than 24 hours the corm or the real plant of these banana and plantain plants which is below ground, is attacked by decomposing fungi and bacteria. This process results in the death of these plants. Tropical areas that are flooded where tropical fruit trees are grown are also subjected to root rot or foot rot when flooding inundates the soil where these plants are being grown. Currently no method exists to prevent these deaths.

Fungicides, bactericides and insecticides have been applied since the 1950's to control fungi, bacteria, insects and nematodes that attack the plants. These chemical pesticides not only contaminate the environment, pose a danger to workers, leave traces of pesticides in the produce consumed, but are also become quite useless as these pathogens are fast developing resistance to these chemical agents.

U.S. Pat. No. 6,372,238 discloses a process for implanting dry implant sticks into banana and plantain plants for providing nutrients and improving resistance to plant pathogens. The nutrient is slowly released over time and the implant provided reduction of infection by certain pathogens. However, the implant did not obtain the results of the composition of the present invention.

### SUMMARY OF THE INVENTION

An object of this invention is to provide a composition and method of applying the composition to banana and plantain plants to provide protection against the effects of flooding. When banana and plantain plants stand in flood waters for more than 24 hours, the corm of the plants is attacked by fungi and bacteria which results in ultimate death of the plants.

A more specific object of this invention is to provide a liquid systemic inducer composition for application to banana and plantain plants before or after flooding which delays the effects of fungal and bacterial attack on the plant corm in standing water. The composition includes a nutrient or fertilizer which is combined with an microorganismic substance. The nutrient may be an acid, acid salt or salt derived from calcium, phosphorous, potassium, magnesium, manganese, sodium, zinc, copper, iron, cobalt, sulfur or chlorine. The microorganismic substance is bacteria, fungi and viruses. The bacteria, fungi and viruses may be hydrolyzed or may be applied live (viruses are not alive) with extraction.

### DESCRIPTION OF THE PREFERRED EMBODIMENT

We have identified and developed a combination of compounds which when applied as a foliar application prior to flood timesduring floods by aerial applications or injected into the banana or plantain plants prior to flooding as a preventive measure, will elicit a response from these plants called acquired resistance to these decomposing fungi or bacteria to slow down or prevent the decomposition or wet feet or root rot so that these plants have an extra 24 to 48 hours to survive the onslaught of these organisms.

We have discovered that certain natural compounds like bacterial, fungal and viral extracts or the organisms themselves when combined with phosphoric acids, phosphorous acids, phosphite fertilizers or phosphate fertilizer can induce 100% systemic resistance to pathologies in plants such that the need for applying pesticides to these plants to manage diseases such as downy mildew (plasmopara viticola) phytopthera, pythium, black and yellow sigatoka is obviated.

In other words, we have developed products comprising microoganismic substance including microorganisms or extracts of these microorganisms combined with an acid including phosphoric acids, phosphorous acids, phosphorous acids, phosphates, phosphates, or at least one of the salts of calcium, magnesium, potassium, manganese, zinc, copper, iron or sodium which induce plants to develop enough resistance naturally to ward off fungal, bacterial, viral and insect infections such that no pesticides need to be applied. The microorganismic substance includes live microorganisms comprising Bacillus, sp, Trichoderma, sp, and Actinomyces, sp.

The present invention provides a systemic flood resistance inducer that is obtained by combining a phosphorous acid and salts thereof, phosphoric acid and salts thereof or the salts of calcium, magnesium, potassium, zinc, manganese, copper, iron and sodium with extracts of microorganisms. The systemic inducer is applied to plants as a foliar application, or applied to the soil on which the plants are planted or injected into the stem or pseudo stem of these plants. These extracts do not by themselves cause any significant induction or invade the plant as they are not pathogenic, so the 100% effective induction takes place only when these extracts are used in combination with the fertilizers listed above. Growth enchancers or regulators such as betaine, benzothio, diazole, jasmonic acid, cytokinin, auzin and gibberellins, beta amino butyric acid may be combined with the fertilizers and extract to relieve the stress caused by the induction program. Salicylates, oxalates, napthaletes have also showed some induction of resistance, but when combined with the nutrients they add to the induction process effectiveness and with increases in productivity.

### EXAMPLES

Experiment (1) Banana plants and plantain plants were selected in a field where every year the river next to the farm is flooded. The floods recede within 24 hours mostly. If these plants stay inundated for 36 hours or more, these plants will die.

Twentyfour (24) plants were injected monthly with Product I* and (Marked A) for 4 months prior to the flooding window. The product was injected at 1 cc per plant diluted with 4 cc of water for 4 months.

When floods came the water did not recede for 36 hours.

Twentyfour (24) plants Marked B that have not been treated were thus marked and injected with Product I* during the flood and after the flood receded, three more times at monthly intervals in the same way as the batch Marked A.

After the flood receded these 48 plants were injected for 3 more months.

Twentyfour (24) plants were Marked C and did not receive any treatment.

Product I* consists of calcium phosphite in a liquid form mixed with extracts of bacillus subtilis and a trichoderma, sp; combined with magnesium and manganese carbonate.

*The results obtained from this trial was as follows:

| | PERCENT | PERCENT |
|---|---|---|
| | LIVE | DIED |
| A) Plants pretreated before | 100% | Zero |
| the floods with 4 injections | | |
| monthly and treated post | | |
| flooding with 3 more | | |
| injections | | |
| B) Plants treated during | 76% | 24% |
| flooding and continued | | |
| post flooding | | |
| C) Plants not treated | Zero | 100% |

What is claimed is:

1. A liquid systemic inducer of plants for providing resistance against decomposing fungus and bacteria and other opportunistic organisms that invade roots and stems of plants that are inundated by floods or excessive rain, a nutrient including an acid or salt derived from an element selected from the group consisting of calcium, phosphorous, potassium, magnesium, manganese, sodium, zinc, copper, iron, cobalt, sulfur or chlorine, combined with extracts of microorganisms selected from the group consisting of bacteria, fungi and viruses, said inducer being applied in anticipation of flooding or during flooding or post flooding and when applied by foliar means to leaves or by injection into the stems or pseudo stems.

2. A systemic inducer as defined in claim 1 wherein the microorganisms are selected from the group consisting of Bacillus, sp; Trichoderma sp; and actinomyces, sp.

3. A systemic inducer as defined in claim 1 wherein the microorganism is hydrolyzed to extract proteins, pesticides, deoxyriboneulotides and riboneucleotides.

4. A systemic inducer as defined in claim 1 wherein the systemic inducer is combined with a growth regulator selected from the group consisting of cytokinins, gribbelins, auxins, jasmonic acid, ethylene and salicylic acid.

5. A systemic inducer as defined in claim 1 wherein the plants are banana or plantains.

6. A systemic inducer as defined in claim 1 wherein by the systemic inducer is applied to a plant via injection.

7. A systemic inducer as defined in claim 1 wherein the systemic inducer is applied as a foliar spray.
